(19) United States
(12) Patent Application Publication
(10) Pub. No.: US 2024/0335841 A1
(43) Pub. Date: Oct. 10, 2024

(54) DUST COLLECTION UNIT, AND ELECTRIC DUST COLLECTION APPARATUS COMPRISING SAME

(71) Applicant: Hanon Systems, Daejeon (KR)

(72) Inventors: Ji-Yong Park, Daejeon (KR); Jae Ho Kim, Daejeon (KR); Su Jin Woo, Daejeon (KR)

(21) Appl. No.: 18/572,308

(22) PCT Filed: Nov. 9, 2022
(86) PCT No.: PCT/KR2022/017525

§ 371 Date: Dec. 20, 2023

(30) Foreign Application Priority Data
Dec. 29, 2021 (KR) 10-2021-0190523

(51) Int. Cl. B03C 3/08; B03C 3/12; B03C 3/47

(52) U.S. Cl. CPC B03C 3/08; B03C 3/12; B03C 3/47

(57) ABSTRACT

The present invention relates to a dust collection unit and an electric dust collection apparatus including the same, and more particularly, to a dust collection unit and an electric dust collection apparatus including the same, in which films are inserted into an insertion groove formed in a casing, and a conductive terminal is inserted to electrically connect the plurality of films at once, thereby easily, conveniently, and electrically connecting the films and stably maintaining electrical connection.

### TECHNICAL FIELD

The present invention relates to a dust collection unit and an electric dust collection apparatus including the same, and more particularly, to a dust collection unit and an electric dust collection apparatus including the same, in which films are inserted into an insertion groove formed in a casing, and a conductive terminal is inserted to electrically connect the plurality of films at once, thereby easily, conveniently, and electrically connecting the films and stably maintaining electrical connection.

### BACKGROUND ART

Examples of air conditioners include a cooler or heater configured to control a temperature of air, an air cleaner configured to maintain cleanliness by removing foreign substances from air, a humidifier configured to provide moisture into air, and a dehumidifier configured to remove moisture in air.

An electric dust collection apparatus refers to an apparatus that is provided independently or mounted in the air conditioner and collects dust particles contained in air by electrically charging the dust particles.

The electric dust collection apparatus broadly includes an electrification unit configured to form an electric field, and a dust collection unit configured to collect dust particles electrically charged by the electrification unit. Dust contained in air is collected by the dust collection unit while the air passes through the electrification unit and then passes through the dust collection unit.

The electrification unit electrically charges dust by means of corona discharge between a discharge electrode and a counter electrode that face each other. The dust collection unit collects dust particles, which are electrically charged by the electrification unit and have particular electric charges, by means of an electrical attractive force by using characteristics of opposite charges.

In this regard, Korean Patent No. 1942525, which is the related art, discloses an electric dust collection apparatus in which dust collection unit films, to which different high voltages are applied, are arranged at equal intervals inside a dust collection unit casing, conductor paste is applied and cured to electrically connect the films to a power source, and electrical insulation is ensured by applying an insulating material.

However, in the related art, the cured conductive paste is in contact with a film electrode part. For this reason, there is a problem in that the conductive paste and the electrode part are likely to be disconnected by external stress or the like, and there is a disadvantage in terms of working time and unit price because the conductive paste needs to be applied and cured.

### Document of Related Art

Korean Patent No. 10-1942525 (registered on Jan. 21, 2019)

### DISCLOSURE

### Technical Problem

The present invention has been made in an effort to solve the above-mentioned problem, and an object of the present invention is to provide a dust collection unit and an electric dust collection apparatus including the same, which are capable of easily, conveniently, and electrically connecting films and stably maintaining electrical connection.

### Technical Solution

A dust collection unit according to an embodiment of the present invention is configured to collect electrically charged dust particles and includes: a rim-shaped casing; a plurality of films accommodated in the casing and configured to collect the electrically charged dust particles; and a conductive terminal configured to apply voltages to the plurality of films, in which one end of each of the plurality of films based on a length direction is fixed to one side of the casing, and the other end of each of the plurality of films based on the length direction is fixed to the other side of the casing, and in which the conductive terminal is disposed on at least one of one side and the other side of the casing and electrically connects the plurality of films.

The conductive terminal may include: a long body; and a plurality of contact protrusions protruding in one direction from the body.

The films may each have a structure in which an electrode layer is interposed between a first insulation film and a second insulation film, an electrode exposure portion may be formed on one end and at least one of two opposite ends of each of the films based on the length direction, and a part of the electrode layer may be exposed to the outside through the electrode exposure portion.

A connection structure in which the conductive terminal and one end or the other end of each of the films based on the length direction are disposed and the conductive terminal and each of the films are electrically connected may be provided on at least one of one side and the other side of the casing, the connection structure may be formed as a structure in which a plurality of insertion grooves and a plurality of protruding portions are alternately formed along one side or the other side of the casing, and when an end of each of the films at which the electrode exposure portion is formed is referred to as an exposure end, the exposure ends of the films may be inserted into the insertion grooves of the connection structure, the contact protrusions of the conductive terminal may be inserted into the insertion grooves of the connection structure, such that the electrode exposure portions of the films and the contact protrusions may be in contact with one another.

The contact protrusions of the conductive terminal may be respectively physically inserted and fitted into the insertion grooves of the connection structure.

The electrode exposure portion may be formed on a front surface of the exposure end of each of the films, and a rear surface of the exposure end may be disposed to be in close contact with the protruding portion.

The electrode exposure portion may have an area larger than a contact area of the contact protrusion being in contact with the electrode exposure portion.

An insulating material may be inserted into the insertion groove of the connection structure, such that the electrode exposure portion of the film is insulated and sealed.

A guide groove may be recessed inward in the protruding portion of the connection structure while traversing an upper surface of the protruding portion, and at least a part of the body of the conductive terminal may be inserted into the guide groove so that a position of the body is fixed.

The conductive terminal may have a shape further including a plurality of guide protrusions protruding in one direction from the body, the guide protrusion may be formed at a position corresponding to the guide groove such that at least a part of the guide protrusion is formed in the guide groove, and an end of the guide protrusion may be formed in a curved shape.

An inclined guide surface may be formed on an upper portion of the protruding portion of the connection structure and inclined toward the insertion groove.

Interval maintaining parts may be respectively provided at one side and the other side of the casing to maintain intervals between the films, the interval maintaining part may include: first fixing portions each configured to support one surface of each of the films; and second fixing portions each configured to support the other surface of each of the films, and the first fixing portion and the second fixing portion may be disposed in an oblique direction with respect to each other.

Inclined guide surfaces may be respectively formed on an upper portion of the first fixing portion and an upper portion of the second fixing portion and inclined toward a gap between the first fixing portion and the second fixing portion.

A dust collection unit set, which includes the casing, the plurality of films, and the conductive terminal, may be provided as a single dust collection unit set constituting a single-layer structure, or the dust collection unit set may be provided as a plurality of dust collection unit sets stacked in an upward/downward direction to constitute a multilayer structure.

An electric dust collection apparatus according to another embodiment of the present invention may include: an electrification unit configured to electrically charge dust particles by receiving a voltage; and the dust collection.

### Advantageous Effects

According to the dust collection unit of the present invention, the films may be inserted into the insertion grooves formed in the casing, and the conductive terminal is inserted into the insertion grooves, such that the plurality of films may be electrically connected to one another at once, thereby easily, conveniently, and electrically connecting the films.

In addition, because the respective components are physically fastened, the electrical connection may be stably maintained even though the entire dust collection unit is deformed by external stress or the like.

In addition, there are advantages in terms of workability and unit price because the electrical connection is completed only by disposing the films in the casing and inserting the conductive terminal.

### BRIEF DESCRIPTION OF THE DRAWINGS

FIG. 1 is a perspective view of an electric dust collection apparatus according to an example of the present invention.

FIG. 2 is a view schematically illustrating FIG. 1.

FIG. 3 is a perspective view of a dust collection unit according to the example of the present invention.

FIG. 4 is an enlarged view of part A in FIG. 3.

FIG. 5 is a view illustrating FIG. 4 when viewed in another direction.

FIG. 6 is a perspective view of a casing according to the example of the present invention.

FIG. 7 is a front view illustrating a film according to the example of the present invention when viewed from the front side.

FIG. 8 is a top plan view illustrating part B in FIG. 7 when viewed from the top side.

FIG. 9 is a view illustrating a conductive terminal according to the example of the present invention.

FIG. 10 is an enlarged view of part A in FIG. 6.

FIG. 11 is a top plan view illustrating FIG. 10 when viewed from the top side.

FIG. 12 is a view illustrating a state in which the film is inserted into an insertion groove.

FIG. 13 is a view illustrating FIG. 12 when viewed from the top side.

FIG. 14 is a view illustrating a state in which the conductive terminal is inserted into the insertion groove into which the film is inserted.

FIG. 15 is a view illustrating FIG. 14 when viewed from the top side.

FIG. 16 is a view illustrating a structure in which the film and the conductive terminal are inserted into the insertion groove and coupled to each other.

FIG. 17 is a view illustrating FIG. 16 when viewed from the lateral side.

### MODE FOR INVENTION

Hereinafter, the present invention will be described with reference to the accompanying drawings.

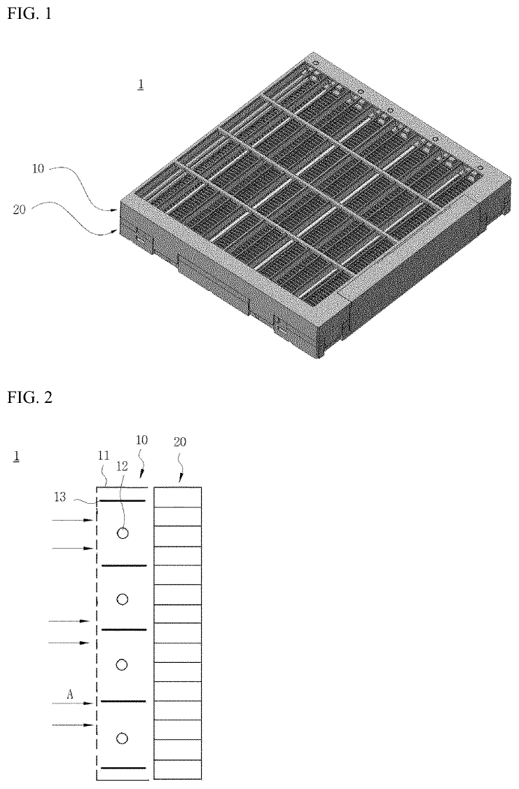

FIG. 1 is a perspective view of an electric dust collection apparatus according to an example of the present invention, and FIG. 2 is a view schematically illustrating FIG. 1. As illustrated, an electric dust collection apparatus 1 broadly includes an electrification unit 10 configured to form an electric field, and a dust collection unit 20 configured to collect dust particles electrically charged by the electrification unit.

The electrification unit 10 may include a rim-shaped casing 11 having a central portion formed therethrough in a direction A in which dust is introduced, electrification plates 12 that are electrification electrodes provided in parallel with the direction in which dust is introduced, and discharge wires 13 that are discharge electrodes disposed between the electrification plates 12.

The dust collection unit 20 serves to collect the electrically charged dust particles. The present invention relates to the dust collection unit 20 of the electric dust collection apparatus 1, and the dust collection unit 20 will be specifically described below.

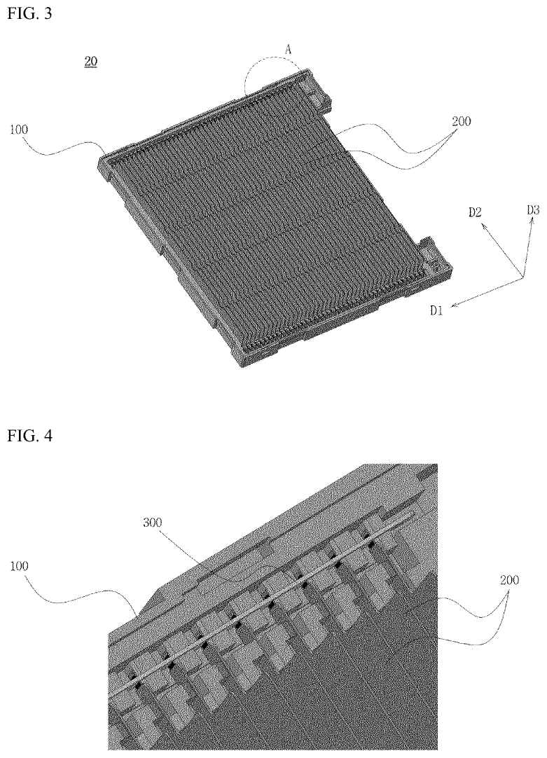

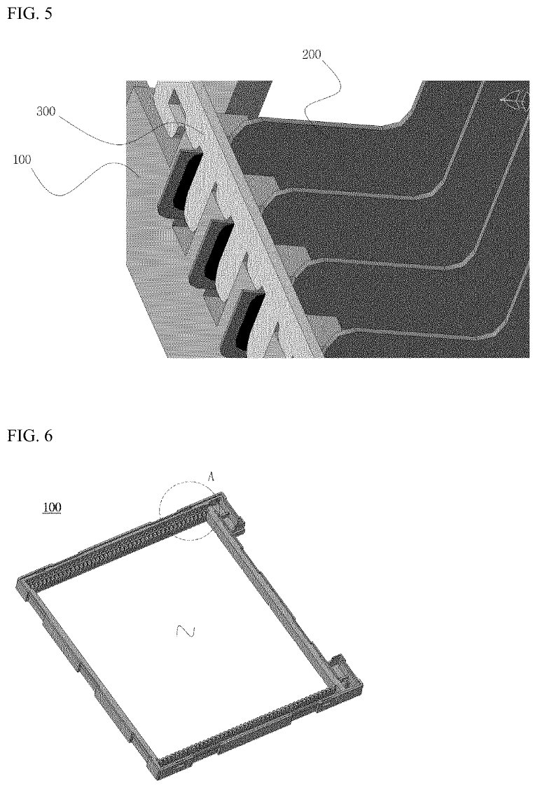

FIG. 3 is a perspective view of the dust collection unit according to the example of the present invention, FIG. 4 is an enlarged view of part A in FIG. 3, and FIG. 5 is a view illustrating FIG. 4 when viewed in another direction. As illustrated, the dust collection unit 20 of the present invention may broadly include a casing 100, films 200, and a conductive terminal 300.

The casing 100 may be configured in the form of a rim. FIG. 6 is a perspective view of the casing according to the example of the present invention. The casing 100 may be formed in a rim shape having a central portion formed therethrough so that dust particles may pass through the central portion, such that the air may be introduced into the penetrated central portion and pass through the central portion. As illustrated, the casing 100 may be formed in a quadrangular shape as a whole. Alternatively, the casing 100 may be formed in a circular or polygonal shape.

The film 200 serves to collect the electrically charged dust particles. As illustrated in FIG. 3, a plurality of films 200 may be arranged in parallel and spaced apart from one another at predetermined intervals in an alignment direction D1, and the plurality of films 200 may be accommodated in the casing 100. One end of the film 200 based on a length direction D2 may be fixed to one side of the casing 100, and the other end of the film 200 based on the length direction D2 may be fixed to the other side of the casing 100.

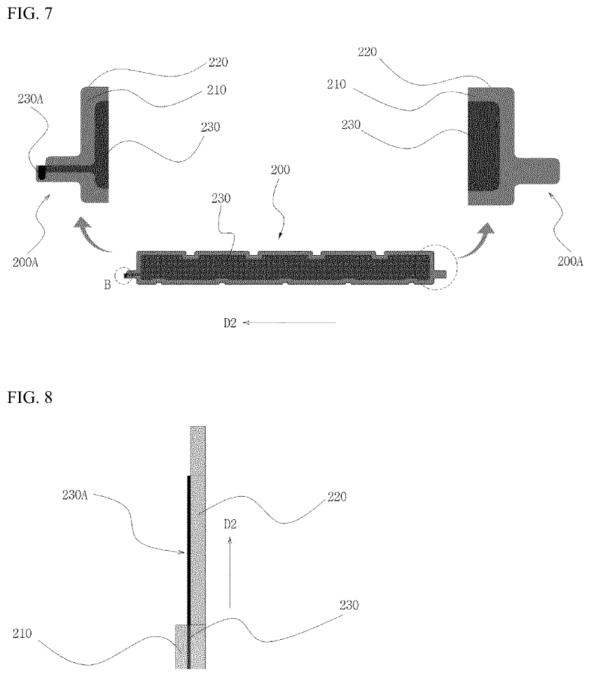

The film 200 will be specifically described. FIG. 7 is a front view illustrating the film according to the example of the present invention when viewed from the front side, and FIG. 8 is a top plan view illustrating part B in FIG. 7 when viewed from the top side. The film 200 may have a structure in which an electrode layer 230 is interposed between a first insulation film 210 and a second insulation film 220 and a rim of the electrode layer 230 is sealed. An electrode exposure portion 230A, through which a part of the electrode layer 230 is exposed to the outside, may be formed on at least one of two opposite ends of the film 200 based on the length direction.

As illustrated, the film 200 may be elongated in the length direction D2. Predetermined protruding blade portions 200A may be provided at one end of the film 200 based on the length direction and the other end of the film 200 based on the length direction. The blade portions 200A may be fixedly inserted into insertion grooves 111 formed in the casing 100. The details will be described below.

In this case, the electrode exposure portion 230A may be formed on at least one of the blade portions 200A provided at the two opposite sides of the film 200. The electrode exposure portion 230A may be formed as the electrode layer 230 is exposed to the outside at a particular position as at least one of the first and second insulation films 210 and 220, which are disposed at the two opposite surfaces of the electrode layer 230, is not formed at the particular position. In addition, as illustrated, the blade portion 200A, on which the electrode exposure portion 230A is not formed, may be formed only by the first and second insulation films 210 and 220 sealed from each other.

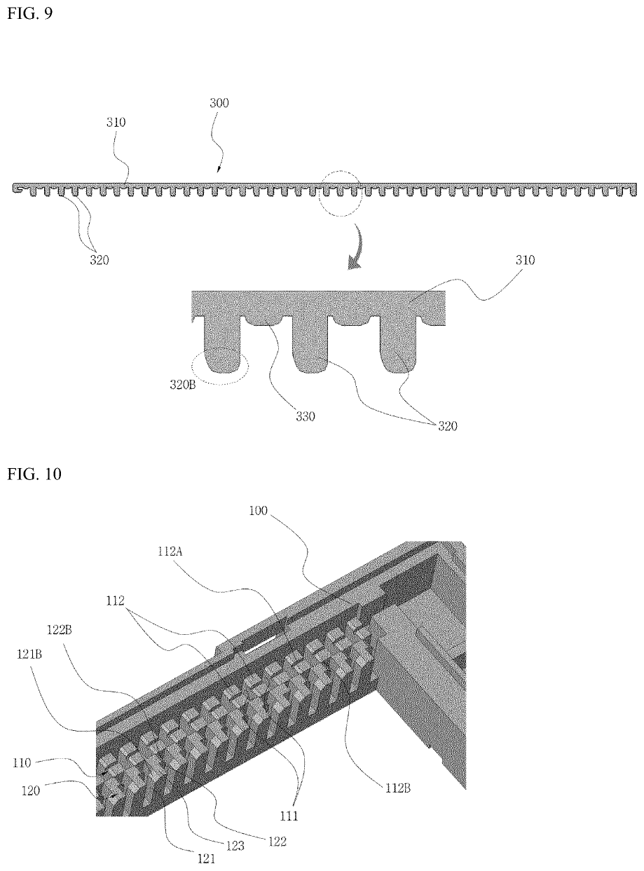

The conductive terminal 300 may be disposed on at least one of one side and the other side of the casing 100 and electrically connect the plurality of films 200. That is, the conductive terminal 300 is a kind of busbar configured as a rod-shaped conductor. The conductive terminal 300 may be disposed in the alignment direction D1 at one side or the other side of the casing 100, electrically connected to the films 200, and configured to transmit voltages to the films 200. More specifically, FIG. 9 is a view illustrating the conductive terminal according to the example of the present invention. The conductive terminal 300 may include a long body 310, a plurality of contact protrusions 320 protruding in one direction from the body 310. The body 310 may be provided in the form of a long rod and extend by a length corresponding to one side or the other side of the casing 100. The contact protrusions 320 have the same size and shape and be spaced apart from one another at equal intervals. A tip portion 320B of the contact protrusion 320 may have a curved rim, which facilitates the insertion of the contact protrusion 320 into the insertion groove 111 formed in the casing 100.

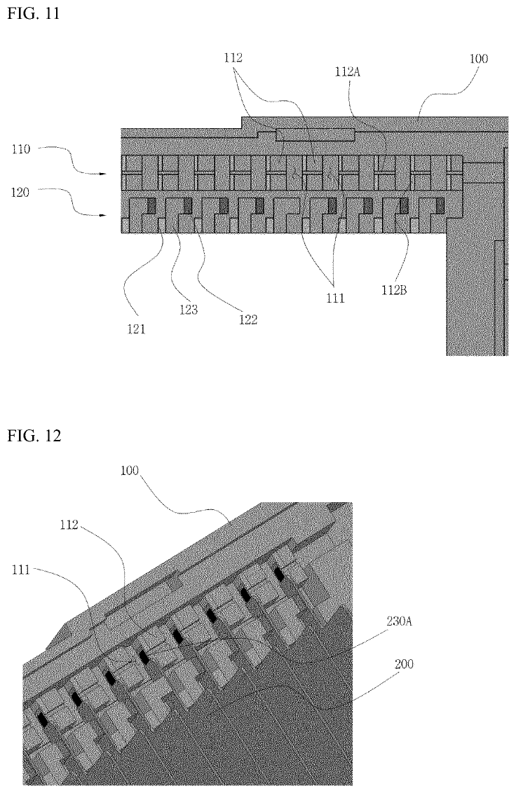

The casing 100 of the present invention will be described more specifically. FIG. 10 is an enlarged view of part A in FIG. 6, and FIG. 11 is a top plan view illustrating FIG. 10 when viewed from the top side. As illustrated, a predetermined connection structure 110 may be provided at one side in the casing 100, and the connection structure 110 may have a structure in which the plurality of insertion grooves 111 and a plurality of protruding portions 112 are alternately formed along one side of the casing 100. The connection structure 110 may be disposed not only on one side of the casing 100 but also on at least one of one side and the other side of the casing 100. Hereinafter, for convenience of description, as in the illustrated example, the description will be focused on the configuration in which the connection structure 110 is formed at one side of the casing 100.

Further, in this regard, as described above, the electrode exposure portion 230A may be formed on at least one of the blade portions 200A disposed at one end and the other end, i.e., the two opposite sides of the film 200 based on the length direction. Hereinafter, for convenience of description, as in the illustrated example, the description will be focused on the configuration in which the electrode exposure portion 230A is formed at one side of the film 200 based on the length direction. In this case, the end of the film 200, at which the electrode exposure portion 230A is formed, will be referred to as an exposure end.

The connection structure 110, in which the insertion grooves 111 and the protruding portions 112 are alternately disposed along one side of the casing 100, may be provided at one side of the casing 100 of the dust collection unit 20 of the present invention. In this case, the exposure ends of the films 200 are inserted into the insertion grooves 111 of the connection structure 110, and the contact protrusions 320 of the conductive terminal 300 are inserted into the insertion grooves 111, such that the electrode exposure portions 230A of the films 200 may be in contact with the contact protrusions 320.

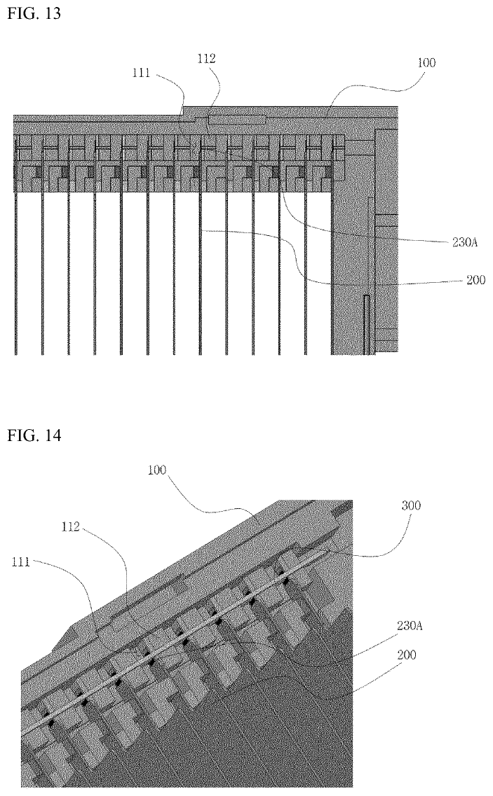

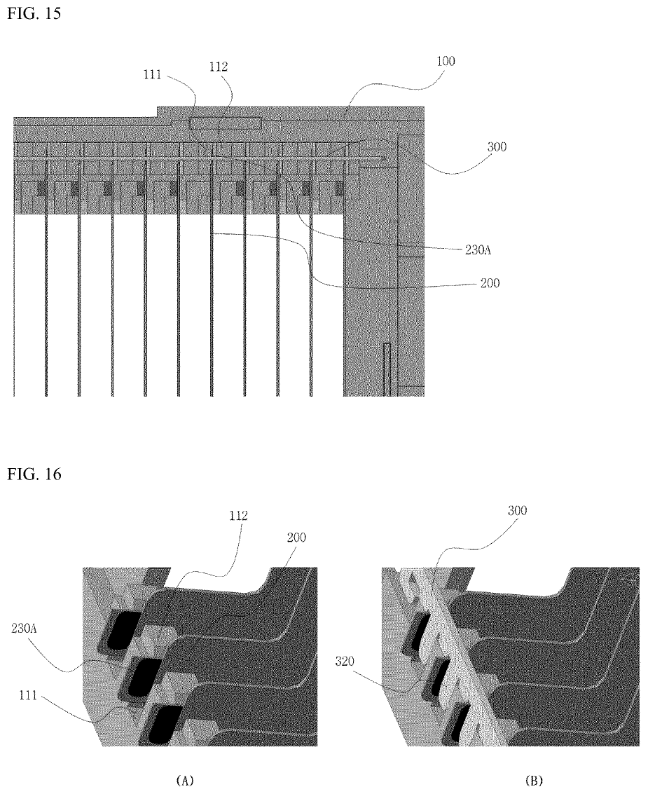

FIG. 12 is a view illustrating a state in which the films are inserted into the insertion grooves, and FIG. 13 is a view illustrating FIG. 12 when viewed from the top side. As illustrated, the exposure end of the film 200, i.e., the end of the film 200, at which the electrode exposure portion 230A is formed, may be identical in the insertion groove 111. Further, FIG. 14 is a view illustrating a state in which the conductive terminal is inserted into the insertion grooves into which the films are inserted, and FIG. 15 is a view illustrating FIG. 14 when viewed from the top side. As illustrated, the conductive terminal 300 may be disposed and seated on one side of the casing 100, and the contact protrusions 320 of the conductive terminal 300 are inserted into the insertion grooves 111 into which the exposure ends of the films 200 are inserted, such that the electrode exposure portions 230A of the films 200 may be respectively in contact with the contact protrusions 320.

In this case, a width of the contact protrusion 320 may be substantially equal to a width of the insertion groove 111, such that the contact protrusion 320 may be physically inserted and fitted into the insertion groove 111.

In addition, with reference to the film 200 inserted into the insertion groove 111, the electrode exposure portion 230A may be formed on a front surface of the exposure end of the film 200, and a rear surface of the exposure end of the film 200 may be disposed to be in close contact with the protruding portion 112. That is, the film 200 may be inserted into the insertion groove 111 so that the film 200 is in close contact with a wall surface of the protruding portion 112 disposed at one side of the insertion groove 111. Therefore, the contact protrusion 320 of the conductive terminal 300 may be easily inserted into the insertion groove 111 into which the film 200 is inserted.

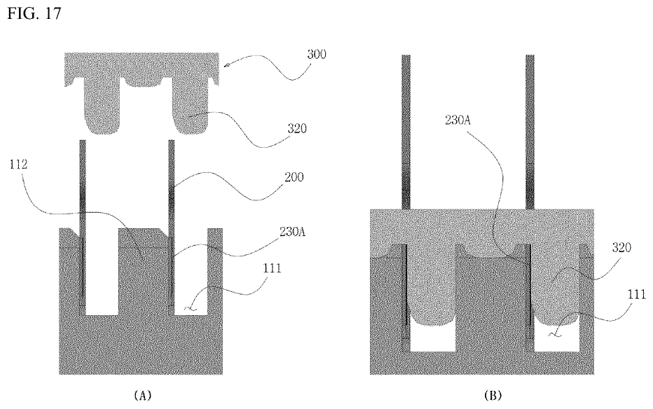

FIG. 16 is a view illustrating a structure in which the films and the conductive terminals are inserted into the insertion grooves and coupled to one another. FIG. 16A illustrates that the films are inserted into the insertion grooves, and FIG. 16B illustrates that the conductive terminal is inserted into the insertion grooves into which the films are inserted. FIG. 17 is a view illustrating FIG. 16 when viewed from the lateral side. FIG. 17A illustrates that the films are inserted into the insertion grooves, and FIG. 17B illustrates that the conductive terminal inserted into the insertion grooves into which the films are inserted.

That is, in the dust collection unit 20 of the present invention, the plurality of insertion grooves 111 is formed at one side in the casing 100, the ends of the films 200, at which the electrode exposure portions 230A are formed, are inserted and seated in the insertion grooves 111, and the contact protrusions 320 of the conductive terminal 300 are inserted and fitted into the insertion grooves 111 into which the films 200 are inserted, such that the electrode exposure portions 230A of the films 200 are in contact with the contact protrusions 320. Therefore, the plurality of films 200 may be electrically connected at once.

As described above, according to the present invention, the conductive terminal is inserted and physically fastened between the casing and the exposed electrodes of the films, such that the plurality of films may be electrically connected to one another at once by means of the single process of fastening the conductive terminal. Therefore, the films may be easily, conveniently, and electrically connected to one another in the dust collection unit.

In addition, because the respective components are physically fastened, the electrical connection may be stably maintained even though the entire dust collection unit is deformed by external stress or the like. More specifically, in the related art described above, in case that the dust collection unit is deformed by external stress or the like, the cured conductive paste may be separated from the film, which may cause electric disconnection. In contrast, according to the present invention, the electrical connection may be properly maintained without the above-mentioned problem even though the dust collection unit is deformed.

Further, there are advantages in terms of workability and unit price because the electrical connection is completed only by disposing the films in the casing and inserting the conductive terminal.

With reference back to FIG. 16, as illustrated, the electrode exposure portion 230A may have an area larger than a contact area of each of the contact protrusions 320 being in contact with the electrode exposure portions 230A. That is, an area in which the electrode layer 230 corresponding to the electrode exposure portion 230A is exposed may be larger than a thickness of the conductive terminal 300. Therefore, the two components may be in contact with each other in a larger range, such that the electrical connection may be easily implemented, and the electrical connection may be advantageously maintained.

In this case, although not illustrated, an insulating material (silicone, rubber, etc.) may be inserted into the insertion groove 111, such that the remaining part of the electrode exposure portion 230A, which excludes a contact surface being in contact with the contact protrusion 320, may be insulated and sealed by the insulating material. In addition, although not illustrated, at the same time or selectively, an insulation cap may be provided above the conductive terminal 300 and close the conductive terminal 300. The insulating material or the insulation cap may improve the insulation from the outside, which may improve the mechanical stability.

With reference back to FIGS. 10 and 11, a guide groove 112A may be formed in an upper surface of each of the protruding portions 112 of the connection structure 110. The guide groove 112A may be provided in the form of a groove recessed inward while traversing the upper surface of the protruding portion 112, and at least a part of the body 310 of the conductive terminal 300 is inserted into the guide groove 112A, such that the position thereof may be fixed. Because the guide grooves are formed in the protruding portions as described above, the position of the conductive terminal may be easily and accurately fixed in the casing, and the conductive terminal may be securely fixed even without an additional member. In addition, as illustrated in FIG. 9, predetermined protruding guide protrusions 330 protruding downward may be further formed between the contact protrusions 320 of the conductive terminal 300 and correspond to the guide grooves 112A. An end of the guide protrusion 330 may have a curved rim, such that the guide protrusion 330 may be easily inserted into the guide groove 112A.

In addition, with reference back to FIGS. 10 and 11, an inclined guide surface 112B may be formed on an upper portion of each of the protruding portions 112 of the connection structure 110 and inclined toward the insertion groove 111. That is, the inclined guide surface 112B may be formed on the upper portion of the protruding portion 112 and inclined from above to below by a predetermined length toward the insertion groove 111 at one side corresponding to the upper portion of the protruding portion 112. Therefore, an inlet of the insertion groove 111 may be wider than an internal space of the insertion groove 111. This may allow the film to be easily inserted into the insertion groove by being guided along the inclined surface at the time of inserting the film into the insertion groove.

Meanwhile, as described above, the plurality of films 200 is disposed to be spaced apart from one another at predetermined intervals in the alignment direction D1. In this case, the intervals need to be appropriately maintained so that the films 200 are not in contact with one another. To this end, interval maintaining parts 120 may be provided at one side and the other side of the casing 100 of the present invention and maintain the intervals between the films 200. With reference back to FIGS. 10 and 11, the interval maintaining part 120 may be provided at one side of the casing 100, i.e., provided inside the connection structure 110. The interval maintaining part 120 may include first fixing portions 121 each configured to support one surface of each of the films 200, and second fixing portions 122 each configured to support the other surface of each of the films 200.

In this case, as illustrated, the first fixing portion 121 and the second fixing portion 122 may be disposed in an oblique direction with respect to each other. That is, the film 200 may be inserted between the first fixing portion 121 and the second fixing portion 122 in a state in which surfaces of the first and second fixing portions 121 and 122, which support the film 200, do not overlap each other. Because the film is very thin, it is difficult to form a thin groove in the casing so that the thin groove corresponds to the film, and it is difficult to insert the film into the thin groove. In contrast, according to the present invention, as described above, the first fixing portion and the second fixing portion are installed in the diagonal direction, and the film is inserted between the first fixing portion and the second fixing portion, which may solve the above-mentioned problem. FIGS. 10 and 11 illustrate only the interval maintaining part 120 provided at one side of the casing 100. However, the interval maintaining part 120 having the same structure may also be provided at the other side of the casing 100.

In addition, the interval maintaining part 120 may further include central portions 123 disposed between the first fixing portions 121 and the second fixing portions 122. The interval maintaining part 120 may have a structure in which the first fixing portion 121 protrudes toward one side from the central portion and the second fixing portion 122 protrudes toward the other side from the central portion 123. This is a specific embodiment capable of easily installing the first fixing portions and the second fixing portions in the oblique direction, and the mechanical durability of the interval maintaining part may also be ensured by adopting this structure. In this case, of course, the first fixing portion may support one surface of a first film, and the second fixing portion may support the other surface of a second film adjacent to the first film.

Further, as illustrated in FIGS. 10 and 11, predetermined inclined guide surfaces 121B and 122B may be formed on upper portions of the first fixing portions 121 and upper portions of the second fixing portions 122 and inclined toward gaps between the first fixing portions 121 and the second fixing portions 122 into which the films 200 are to be inserted. The inclined guide surfaces 121B and 122B serve to perform the same functions as the inclined guide surface 112B of the protruding portion 112. Because the inclined surfaces are formed on the upper portions of the first and second fixing portions as described above, the film may be easily inserted by being guided between the first and second fixing portions.

Meanwhile, the dust collection unit 20 of the present invention may be configured as a single-layer or multilayer structure. When the dust collection unit 20 is configured as a single-layer or multilayer structure, the dust collection unit 20 corresponding to the layer may be configured such that the connection structure 110 may be formed only at one side in the casing 100 or the connection structures 110 may be formed at both the two opposite sides.

That is, in order for the dust collection unit to collect the electrically charged dust particles, different voltages need to be applied to collect the electrically charged dust particles in different amounts. This may be implemented by the single-layer structure by means of a single dust collection unit set or the multilayer structure by stacking a plurality of dust collection unit sets in an upward/downward direction D3. In this case, the dust collection unit set may include the casing 100, the plurality of films 200, the conductive terminal 300, and the other structures, e.g., the connection structure 110, the interval maintaining part 120, and the like.

For example, in case that the dust collection unit sets constitute the multilayer structure, the dust collection unit set structure of any one layer may be configured such that the electrode exposure portions of the plurality of films are each formed at one end of each of the films based on the length direction, and the conductive terminal may be provided at one end of each of the films, and the dust collection unit set structure of another layer may be configured such that the electrode exposure portion and the conductive terminal provided at the other side of each of the films, on the contrary. Further, different voltages, e.g., different voltages such as a high-potential voltage and a low-potential voltage may be applied to the film of the dust collection unit set of any one layer and the film of the dust collection unit set of another layer.

In addition, in case that the dust collection unit set constitutes the single-layer structure, the plurality of films may include the first and second films having the electrode exposure portions formed to be opposite to each other. The conductive terminals may be respectively provided at one side and the other side of the casing, the conductive terminal provided at one side of the casing may electrically connect the first films, and the conductive terminal provided at the other side of the casing may electrically connect the second films. In this case, the first films and the second films may be alternately disposed one by one, and the voltage applied to the first film and the voltage applied to the second film may be different from each other. Further, the dust collection unit may be finally configured by stacking the plurality of dust collection unit sets each constituting the single-layer structure including the first and second films.

While the embodiments of the present invention have been described with reference to the accompanying drawings, those skilled in the art will understand that the present invention may be carried out in any other specific form without changing the technical spirit or an essential feature thereof. Therefore, it should be understood that the above-described embodiments are illustrative in all aspects and do not limit the present invention.

### DESCRIPTION OF REFERENCE NUMERALS

1: Electric dust collection apparatus
10: Electrification unit
20: Dust collection unit
100: Casing
110: Connection structure
111: Insertion groove
112: Protruding portion
120: Interval maintaining part
121: First fixing portion
122: Second fixing portion
123: Central portion
200: Film
200A: Blade portion
210: First insulation film
220: Second insulation film
230: Electrode layer
230A: Electrode exposure portion
300: Conductive terminal
310: Body
320: Contact protrusion
330: Guide protrusion

What is claimed is:

1. A dust collection unit, which is configured to collect electrically charged dust particles, the dust collection unit comprising:
a rim-shaped casing;
a plurality of films accommodated in the casing and configured to collect the electrically charged dust particles; and
a conductive terminal configured to apply voltages to the plurality of films,
wherein one end of each of the plurality of films based on a length direction is fixed to one side of the casing, and the other end of each of the plurality of films based on the length direction is fixed to the other side of the casing, and
wherein the conductive terminal is disposed on at least one of one side and the other side of the casing and electrically connects the plurality of films.

2. The dust collection unit of claim 1, wherein the conductive terminal comprises:
a long body; and
a plurality of contact protrusions protruding in one direction from the body.

3. The dust collection unit of claim 2, wherein the films each have a structure in which an electrode layer is interposed between a first insulation film and a second insulation film, and
wherein an electrode exposure portion is formed on one end and at least one of two opposite ends of each of the films based on the length direction, and a part of the electrode layer is exposed to the outside through the electrode exposure portion.

4. The dust collection unit of claim 3, wherein a connection structure in which the conductive terminal and one end or the other end of each of the films based on the length direction are disposed and the conductive terminal and each of the films are electrically connected is provided on at least one of one side and the other side of the casing,
wherein the connection structure is formed as a structure in which a plurality of insertion grooves and a plurality of protruding portions are alternately formed along one side or the other side of the casing, and
wherein when an end of each of the films at which the electrode exposure portion is formed is referred to as an exposure end, the exposure ends of the films are inserted into the insertion grooves of the connection structure, and the contact protrusions of the conductive terminal are inserted into the insertion grooves of the connection structure, such that the electrode exposure portions of the films and the contact protrusions are in contact with one another.

5. The dust collection unit of claim 4, wherein the contact protrusions of the conductive terminal are respectively physically inserted and fitted into the insertion grooves of the connection structure.

6. The dust collection unit of claim 4, wherein the electrode exposure portion is formed on a front surface of the exposure end of each of the films, and a rear surface of the exposure end is disposed to be in close contact with the protruding portion.

7. The dust collection unit of claim 4, wherein the electrode exposure portion has an area larger than a contact area of the contact protrusion being in contact with the electrode exposure portion.

8. The dust collection unit of claim 4, wherein an insulating material is inserted into the insertion groove of the connection structure, such that the electrode exposure portion of the film is insulated and sealed.

9. The dust collection unit of claim 4, wherein a guide groove is recessed inward in the protruding portion of the connection structure while traversing an upper surface of the protruding portion, and at least a part of the body of the conductive terminal is inserted into the guide groove so that a position of the body is fixed.

10. The dust collection unit of claim 9, wherein the conductive terminal has a shape further including a plurality of guide protrusions protruding in one direction from the body,
wherein the guide protrusion is formed at a position corresponding to the guide groove such that at least a part of the guide protrusion is formed in the guide groove, and
wherein an end of the guide protrusion is formed in a curved shape.

11. The dust collection unit of claim 4, wherein an inclined guide surface is formed on an upper portion of the protruding portion of the connection structure and inclined toward the insertion groove.

12. The dust collection unit of claim 3, wherein interval maintaining parts are respectively provided at one side and the other side of the casing to maintain intervals between the films,
wherein the interval maintaining part comprises:
first fixing portions each configured to support one surface of each of the films; and
second fixing portions each configured to support the other surface of each of the films, and
wherein the first fixing portion and the second fixing portion are disposed in an oblique direction with respect to each other.

13. The dust collection unit of claim 12, wherein inclined guide surfaces are respectively formed on an upper portion of the first fixing portion and an upper portion of the second fixing portion and inclined toward a gap between the first fixing portion and the second fixing portion.

14. The dust collection unit of claim 3, wherein a dust collection unit set, which includes the casing, the plurality of films, and the conductive terminal, is provided as a single dust collection unit set constituting a single-layer structure, or the dust collection unit set is provided as a plurality of dust collection unit sets stacked in an upward/downward direction to constitute a multilayer structure.

15. An electric dust collection apparatus comprising:
an electrification unit configured to electrically charge dust particles by receiving a voltage; and
the dust collection unit of claim 1.
